(19) United States
(12) Patent Application Publication
(10) Pub. No.: US 2008/0015034 A1
(43) Pub. Date: Jan. 17, 2008

(54) Torque limiter for a harvester row unit

(75) Inventor: Michael Bennett Downey, Hampton, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/487,854

(22) Filed: Jul. 17, 2006

(51) Int. Cl. F16D 7/04

(52) U.S. Cl. 464/39

(57) ABSTRACT

A torque limiter for a row unit of a harvester has a shell that is threaded on to a limiter base to compress the limiter's spring.

### FIELD OF THE INVENTION

The invention relates to agricultural harvesters. More particularly, it relates to harvesting heads for harvesters. Even more particularly, it relates to drive systems for row units of the heads

### BACKGROUND OF THE INVENTION

Harvester heads for row crops include several laterally disposed row units. Each row unit is oriented to gather and cut a single row of crops. The row units are driven by one or more elongated rotating drive shafts that extend across the width of the harvesting head. A typical drive shaft may be coupled to and drive ten or twelve different row units simultaneously.

The row units are located adjacent to the ground so all the crop plant is gathered for processing. The drive shafts extend across the width of the harvesting head, immediately adjacent to the ground.

In this position, the drive shafts and row units tend to accumulate plant matter lying on the ground. The torque limiters (also known as clutches, jaw clutches or slip clutches) that couple the drive shafts to the row units are particularly prone to being fouled and jammed by this matter due to the several exposed bolts that extend from the torque limiter Furthermore, loosening the torque limiters to remove trash is difficult due to the several bolts that hold the torque limiters together.

What is needed, therefore, is an improved torque limiter for harvester row units that is protected from extraneous matter and that is easier to loosen, clean, adjust, and tighten. It is an object of this invention to provide such a torque limiter.

### SUMMARY OF THE INVENTION

In accordance with a first aspect of the invention, a torque limiter is provided having a compression spring disposed within a shell that is threaded to a base.

### BRIEF DESCRIPTION OF THE DRAWINGS

FIG. 1 is an exploded perspective view of the torque limiter of the present invention.

FIG. 2 is a partial cutaway view of an assembled torque limiter.

### DESCRIPTION OF THE PREFERRED EMBODIMENT

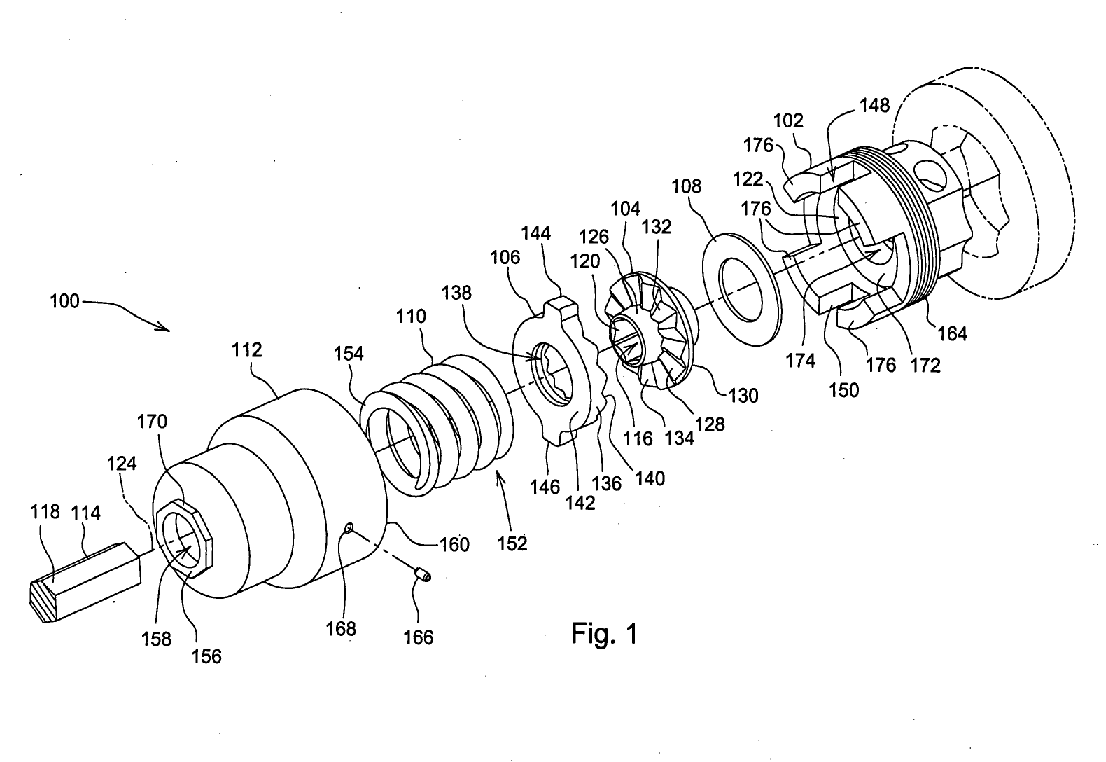

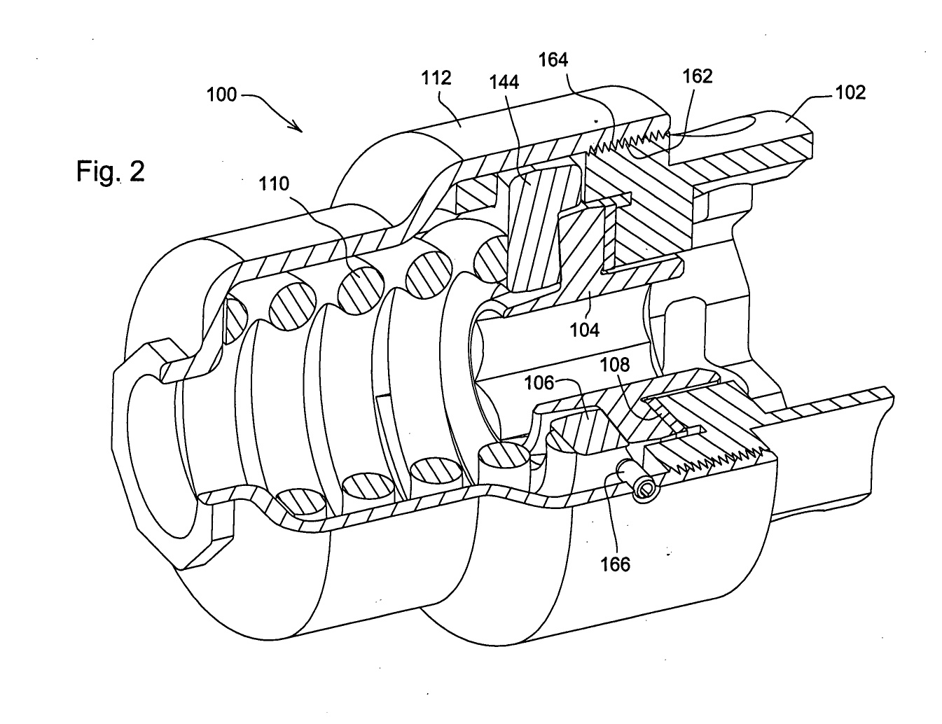

Referring now to FIGS. 1 and 2, a torque limiter (also known as a “slip clutch”) 100 has a base 102 that supports an input plate 104, an output plate 106, a washer 108, a compression spring 110, and a shell 112.

A row unit drive shaft 114 for driving the torque limiter extends though an aperture 116 in the input plate 104 and engages plate 104 to communicate torque to it. The drive shaft 114 has external hexagonal flats 118 that mate with corresponding internal hexagonal flats 120 on the aperture extending through the input plate.

The input plate 104 is supported on a flat annular surface 122 of the base 102 for rotation with respect to the base 102 about a common longitudinal axis 124. The input plate 104 is generally formed as a collar 126 that extends around and engages the drive shaft 114, to which is fixed an outwardly extending flange 128. The flange 128 has one flat surface 130 that engages the base 102, and an opposing surface 132 with radially extending corrugations 134.

The output plate 106 includes a disk 136 with a central aperture 138, the disk 136 having one side that defines a similarly corrugated surface 140 that faces and engages the corrugated surface 140 of the input plate 104 and an opposing side that defines a surface 142 that faces and engages the compression spring 110. The output plate 106 also has two protrusions 144, 146 extending from opposite sides of the disk 136 that are disposed in opposing apertures 148, 150, respectively, formed in the base 102. The apertures 148, 150 and the protrusions 144, 146 are configured such that the output plate 106 communicates torque about the longitudinal axis 124 to the base 102 yet permits the output plate 106 to move in the longitudinal direction sufficiently to permit the output plate 106 to move from a first position in which the corrugations on the input plate 104 and the output plate 106 are intimately engaged to transmit torque one to the other, to a second position in which the input plate 104 and the output plate 106 are axially separated sufficient to permit them to rotate with respect to each other.

The spring 110 is a coiled compression spring having a longitudinal axis 124 that is coaxial with the other components of the torque limiter. It has a first end 152 that faces and engages the second surface of the output plate 106 and a second end 154 that faces and engages the inside surface of the shell 112.

The shell 112 is a generally bell- or cylindrical-shaped structure with a first end 156 that is generally enclosed. The first end 156 defines an aperture 158 that permits the driveshaft 114 to pass therethrough. The internal surface of the second, opposing end 160 of the shell 112 has threads 162 to engage mating threads 164 on the base 102. These threads 162, 164 have a root diameter greater than the outer diameter of the spring 110 and the spring 110 are disposed radially inside the threads 162. The threads 162, 164 are generally coaxial with the spring 110 and extend about the periphery of the spring 110, thereby distributing the spring pressure evenly to the threads 162, 164. A pin 166 is provided that extends through the wall of the shell 112 and into a space adjacent to the output plate 106. The pin 166 is preferably a roll pin and is long enough to engage structures (in this case, the protrusions 144, 146) in order to prevent the shell from completely unthreading itself. The shell 112 can unthread until the pin 166 abuts a protrusion 144, 146, at which point no further unthreading is possible. Structures 170 are provided on the shell 112 for tightening the shell 112 on the base 102, such as splines, holes, wrenching flats, protrusions configured to engage e.g. a tightening tool such as a pin, eye or hook spanner; wrench or rod.

The base 102 of the torque limiter 100 comprises a body 172 having an aperture 174 concentric with the longitudinal axis 124 of the base 102. The body 172 has a flat annular surface 122 generally normal to the longitudinal axis 124, and that faces toward the input 104 and output 106 plates and the spring 110. The washer 108 is disposed between the flat surface 130 of the input plate and the flat surface 122 of the base 102 to reduce friction and wear between the input plate 104 and the base 102. The base 102 includes a generally cylindrical sidewall 176 that is fixed to and extends from the body 172. The apertures 148, 150 that receive the protrusions 144, 146 extending from the output plate 106 are formed in the sidewall 176. The external threads 164 formed in the outer cylindrical surface of the sidewall engage the internal threads 162 formed on the inner surface of the second end 160 of the shell 112.

In use, the shell 112 is threaded onto the base 102, to compress the spring 110. The spring 110 is compressed between the inner surface of the shell, and one side of the output plate. This spring compression forces the corrugated surface of the output plate to be compressed against the mating corrugated surface of the input plate. The input plate, is compressed against the washer, which in turn is compressed against the body. The body is fixed to the sidewall, which is threaded to the shell, both the sidewall and the shell being in tension by the spring.

When a torque less than a predetermined threshold torque is applied to the drive shaft, it tends to rotate the input plate with respect to the output plate. As long as this torque is below the threshold, the two plates will rotate with respect to each other spreading apart and compressing the spring slightly to maintain a torque of equal and opposite value on the input plate. The corrugations will still remain engaged, however, although slightly offset. The torque applied by the input plate through the corrugations to the output plate is then communicated to the two protrusions on the output plate, and thence to sidewalls of the apertures in the base that receive the protrusions. The base then applies the torque through the surface structures of the base to the input gear of the row unit, which is driven thereby.

When the torque exceeds the predetermined threshold torque, the spring is compressed sufficient to permit the input and output plates to rotate with respect to each other, or “slip”, hence the alternative term for this device: a “slip clutch”. In this mode, the drive shaft can spin while the base and the input gear to the row unit remain stationary, or alternatively spin at a speed less than that of the drive shaft. The torque applied to the row unit is thereby limited to the threshold torque. When the torque drops below the predetermined threshold torque the torque limiter automatically resets, the corrugations re-engage rather slip past each other, the input and output plates again rotate in synchrony, and the row unit is driven that the desired speed.

Having described the preferred embodiment, it will become apparent that various modifications can be made without departing from the scope of the invention as defined in the accompanying claims. For example, the shell may have various slots or apertures to permit water to leak out (for example) or to reduce weight. The shell may have external threads on its lower portion that engage internal threads formed on the base. The washer can be removed entirely if wear is not an issue, or replaced with a different structure that reduces wear such as a lubricant or a self lubricating metal. The corrugations can be replaced with any of a variety of different shapes that provide interengagement sufficient to communicate torque while preferably providing the automatic disengagement when torque over a predetermined threshold is applied. The corrugations can even be replaced with friction material, such as the material sued for vehicular brake shoes or brake pads. The protrusion and interengaging aperture arrangement can be reversed by providing apertures on the output plate and protrusions on the base that interengage to prevent the output plate from rotating with respect to the base, thereby communicating torque from the output plate to the base in place of the existing arrangement. Alternatively, the protrusion and interengaging aperture arrangement can be supplemented by providing apertures on the output plate and protrusions on the base that interengage to prevent the output plate from rotating with respect to the base, thereby communicating torque from the output plate to the base. The apertures of the protrusion and aperture pairs can extend completely through the structure in which they are formed, or they can extend only partially into the structure. additional protrusion and aperture pairs can be provided beyond the two illustrated in the figures. The hex flats of the input plate can be replaced with a clamp, splines or other structure that permits the transmission of torque. When the torque converter is used with other input devices that do not need a drive shaft extending through each torque limiter to engage other torque limiters, no aperture passing through the input plate is required, just the provision of mechanical structures of some form that will interengage with a shaft. In some applications, the input plate further comprise a shaft (instead of its illustrated aperture) that extends away from the torque limiter and to which some other shaft such as the drive shaft illustrated herein may be coupled, for example, with a rotary coupling. In another arrangement, the torque limiter may be configured to be disposed inside the row unit itself, rather than, as illustrated here, being disposed adjacent to the row unit and coupled thereto. The spring can be a stack of dished spring washers (often called Belleville washers or disc springs) that are separate or fixed together.

1. A torque limiter for limiting the torque applied to row units of an agricultural harvesting head, the limiter comprising:
a base configured to communicate a drive torque to a row unit;
an output plate coupled to the base and configured to communicate the drive torque to the base;
an input plate drivingly coupled to the output plate and configured to communicate the drive torque to the output plate, the input plate being configured to receive the drive torque from a row unit drive shaft;
a spring disposed to press the input plate against the output plate; and
a shell surrounding the spring and having an aperture at a first end of the shell to receive the row unit drive shaft.

2. The torque limiter of claim 1, wherein the shell is cylindrical and surrounds and abuts an end of the spring.

3. The torque limiter of claim 1, wherein a second end of the shell has threads surrounding the spring.

4. The torque limiter of claim 1, wherein the shell threads are generally coaxial with the spring.

5. The torque limiter of claim 1, wherein the shell further comprises means for tightening the shell on the base.

6. The torque limiter of claim 1, wherein the root diameter of the threads is greater than the width overall of the spring as measured in a direction normal to its longitudinal axis.

7. A torque limiter for limiting the torque applied to row units of an agricultural harvesting head, the limiter comprising:
a base configured to communicate a drive torque to a row unit and having first external threads extending about the periphery of the base;
an output plate coupled to the base and configured to communicate the drive torque to the base;
an input plate drivingly coupled to the output plate and configured to communicate the drive torque to the output plate, the input plate being configured to receive the drive torque from a row unit drive shaft;
a spring disposed to press the input plate against the output plate; and
a shell surrounding the spring and having an aperture at a first end of the shell to receive the row unit drive shaft and having second threads engaging the first threads.

8. The torque limiter of claim 7, wherein the shell is cylindrical and abuts one end of the spring.

9. The torque limiter of claim 7, wherein the second threads surround the spring.

10. The torque limiter of claim 7, wherein the second threads are generally coaxial with the spring.

11. The torque limiter of claim 7, wherein the shell further comprises means for tightening the shell on the base.

12. The torque limiter of claim 7, wherein the root diameter of the second threads is greater than the width overall of the spring as measured in a direction normal to its longitudinal axis.
